(19) United States
(12) Patent Application Publication
(10) Pub. No.: US 2026/0296266 A1
(43) Pub. Date: Oct. 1, 2026

(54) On-Board Electrical System and Method for Providing an On-Board Power System Voltage

(71) Applicant: AUMOVIO Germany GmbH, Frankfurt am Main (DE)

(72) Inventors: Patrick Frölich, Oberursel (DE); Ludwig Ramsauer, Rottenburg (DE)

(73) Assignee: AUMOVIO Germany GmbH, Frankfurt am Main (DE)

(21) Appl. No.: 19/573,042

(22) Filed: Mar. 20, 2026

(30) Foreign Application Priority Data
Mar. 31, 2025 (DE) 10 2025 112 400.0

(51) Int. Cl. B60L 58/20; H02J 7/00; H02J 7/70; H02J 7/90

(52) U.S. Cl. CPC B60L 58/20; H02J 7/751; H02J 7/855; H02J 7/971; B60L 2210/12; B60L 2240/547; B60L 2260/22

(57) ABSTRACT

An on-board electrical system for a motor vehicle, including a DC voltage source which provides a DC voltage having a first voltage level. The on-board electrical system has at least one electrical control unit which is operated in a first operating state of the motor vehicle with an on-board power system voltage according to the first voltage level. The on-board electrical system has a voltage reduction unit which can be actuated in a second operating state of the motor vehicle in such a way that the on-board power system voltage is reduced at least in a part of the on-board power system in which the electrical control unit is provided, such that an on-board power system voltage with a second voltage level which is lower than the first voltage level is applied to the electrical control unit.

### CROSS-REFERENCE TO RELATED APPLICATIONS

This U.S. Utility application claims priority to DE 10 2025 112 400.0, filed Mar. 31, 2025, the disclosure of this application is being incorporated herein by reference in its entirety for all purposes.

### FIELD OF THE INVENTION

The invention relates generally to the field of on-board electrical systems of motor vehicles. In particular, the present invention relates to an on-board electrical system and to a method for providing an on-board power system voltage in an on-board electrical system in which the on-board power system voltage is reduced depending on the operating state.

### BACKGROUND OF THE INVENTION

It is known that motor vehicles have an on-board electrical system with a DC voltage source in the form of an on-board power supply battery which supplies an on-board power system of the motor vehicle with DC voltage. Previous on-board power systems have a rated voltage of 12V. In future, it is planned to increase the on-board power system voltage to 48V.

The problem here is that the 48V on-board power system must also provide power in the parked state or in the rest state of the vehicle, for example for control devices which also provide a basic functionality in the rest state. This applies, for example, to a control device that controls the closing function or the parking brake function of the vehicle.

Due to the higher voltage level, greater leakage currents flow, which leads to higher power losses.

### SUMMARY OF THE INVENTION

Taking this as a starting point, it is an aspect of the invention aims to specify an on-board power system in which the power losses caused by leakage currents are limited despite an increased on-board power system voltage.

According to a first aspect, an on-board electrical system for a motor vehicle is disclosed. The on-board electrical system comprises a DC voltage source that provides a DC voltage having a first voltage level. The on-board electrical system has at least one electrical control unit which is operated in a first operating state of the motor vehicle with an on-board power system voltage according to the first voltage level. The on-board electrical system has a voltage reduction unit which can be actuated in a second operating state of the motor vehicle such that the on-board power system voltage is reduced at least in a part of the on-board power system in which the electrical control unit is provided. As a result, an on-board power system voltage with a second voltage level, which is lower than the first voltage level, is applied to the electrical control unit.

An aspect of the invention provides the technical advantage that, by lowering the on-board power system voltage, the electrical losses arising on account of parasitic effects can be reduced, and therefore the power consumption of the vehicle is reduced. This is advantageous in particular during long standstill periods of the vehicle since excessive draining of the DC voltage source is prevented.

According to an exemplary embodiment, the rated voltage of the first voltage level is 48V or substantially 48V. In other words, the control unit is operated in the first operating state of the vehicle at a rated voltage of 48V. In the case of a 48V on-board power system voltage, the electrical losses which arise owing to parasitic effects are higher than, for example, in 12V on-board electrical systems, such that the reduction of the on-board power system voltage is particularly advantageous here. It should be noted that the control unit is preferably not a control unit of an electric drive, for example of an electric drive of a mild hybrid system, but rather a control device that must be supplied with voltage even in the rest state of the vehicle.

According to an exemplary embodiment, the rated voltage of the second voltage level is in the range between 24V and 40V. The rated voltage in the second operating state of the vehicle is preferably selected in such a way that the control device also still provides at least partial functions in this second operating state of the vehicle. This is the case in accordance with the ISO-21780 standard for reductions of up to 24V. Such a reduction in the on-board power system voltage has the advantage that the electrical losses are significantly reduced.

According to an exemplary embodiment, the voltage reduction unit comprises a switching unit which is coupled to or integrated into a DC voltage source in the form of an on-board power system battery which has a rated voltage of 48V. The on-board power system battery has a first battery pole as a positive pole, a second battery pole as a ground pole, and a center tap. The second voltage level is provided by means of the center tap. This form of voltage reduction unit makes it possible to reduce the on-board power system voltage in a technically simple manner and with low electrical losses.

According to an exemplary embodiment, the switching unit causes a switchover between an electrical connection to the first battery pole and an electrical connection to the center tap. In the first switch state, in which the output of the switching unit is electrically coupled to the first battery pole, an on-board power system voltage is provided in accordance with the first voltage level. In contrast, in the second switching state, in which the output of the switching unit is electrically coupled to the center tap, an on-board power system voltage according to the second voltage level, that is, a reduced on-board power system voltage, is provided. As a result, a voltage reduction can be achieved with low electrical losses.

According to an exemplary embodiment, the voltage reduction unit has a DC-DC converter. The DC-DC converter can be integrated in the DC voltage source of the vehicle or else can be provided at a distance therefrom, for example in order to supply only a partial region of the on-board electrical system with a reduced operating voltage.

According to an exemplary embodiment, the voltage reduction unit is integrated in a drive battery of the vehicle. The on-board power system voltage with the first and second voltage levels is provided by this drive battery in this case. As a result, it is possible for the functionality of the on-board power system battery to be provided by the drive battery. A simple construction of the vehicle is thereby achieved.

In this case, it is preferable that no on-board power system battery is provided as a separate battery in addition to the drive battery.

According to an exemplary embodiment, the DC-DC converter is coupled to an on-board power system battery of the vehicle, which has a rated voltage of 48V or substantially 48V. The DC-DC converter is designed to reduce the on-board power system voltage from the first voltage level to the second voltage level. The operating voltage of a 48V on-board power system battery can thus be lowered to a desired voltage level, specifically without asymmetrical loading, as is the case, for example, with a center tap on the on-board power system battery.

According to an exemplary embodiment, the second operating state of the vehicle is a rest state and/or a parked state. The reduction in the on-board power system voltage is particularly advantageous in the rest state and/or parked state because, as a result, the discharging of the DC voltage source (i.e., the on-board power system battery or the drive battery) is reduced even during long standstill periods of the vehicle.

According to an exemplary embodiment, the reduction of the on-board power system voltage to the second voltage level can be parameterized in such a way that the on-board power system voltage is reduced to the second voltage level if at least one further condition is satisfied in addition to assuming the parked state and/or the rest state of the vehicle. A condition may for example be the period for which the vehicle is in the rest state and/or in the parked state. Another or additional condition can be, for example, the charge level of the DC voltage source. A reduction of the on-board power system voltage can thus be brought about depending on certain parameters.

According to an exemplary embodiment, the on-board power system of the vehicle has a plurality of on-board power system sections. The reduction of the on-board power system voltage to the second voltage level takes place only in some of the on-board power system sections. As a result, it is possible, for example, to cause a reduction in the on-board power system voltage only in those regions of the on-board power system which have components that are to be supplied with power in the second operating state.

According to a further aspect, a vehicle is disclosed. The vehicle has an on-board electrical system according to any one of the embodiments described above.

According to yet a further aspect, a method for providing an on-board power system voltage in an on-board electrical system of a motor vehicle is disclosed. The on-board electrical system has a DC voltage source by which a DC voltage at a first voltage level is provided. The on-board electrical system comprises at least one electrical control unit which is supplied with an on-board power system voltage according to the first voltage level in a first operating state of the vehicle. The on-board electrical system has a voltage reduction unit by means of which the on-board power system voltage can be reduced. The method comprises the following steps:
receiving information indicating that the motor vehicle has assumed a second operating state which is different from the first operating state;
actuating the voltage reduction unit;
reducing the on-board power system voltage at least in a part of the on-board power system in which the electrical control unit is provided, such that an on-board power system voltage with a second voltage level which is lower than the first voltage level is applied to the electrical control unit.

In the context of an aspect of the invention, the expressions “approximately,” “substantially,” or “about” mean deviations from the respective exact value of +/−10%, preferably of +/−5%, and/or deviations in the form of changes that are insignificant for the function.

Developments, advantages and possible uses of an aspect of the invention will be apparent from the following description of exemplary embodiments and from the figures. Here, all the features described and/or illustrated in the figures are, in principle, the subject matter of an aspect of the invention, individually or in any desired combination, irrespective of whether they are summarized in the claims or the dependencies thereof. The content of the claims is also made an integral part of the description.

### BRIEF DESCRIPTION OF THE DRAWINGS

Aspects of the invention will be explained in greater detail below based on the figures and exemplary embodiments. In particular:

FIG. 1 shows, by way of example, a schematic representation of an on-board electrical system according to a first exemplary embodiment;

FIG. 2 shows, by way of example, a schematic representation of an on-board electrical system according to a second exemplary embodiment;

FIG. 3 shows, by way of example, a schematic representation of an on-board electrical system according to a third exemplary embodiment; and

FIG. 4 shows, by way of example, a block diagram which discloses the method steps of a method for providing an on-board power system voltage.

### DETAILED DESCRIPTION OF EXEMPLARY EMBODIMENTS

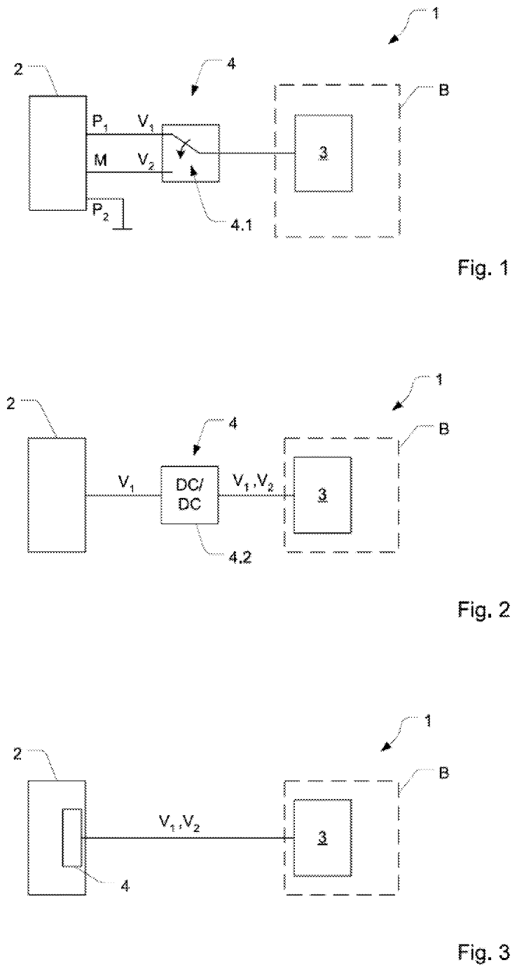

FIG. 1 shows an on-board electrical system 1 by way of example and schematically. The on-board electrical system 1 comprises an on-board power system B of a motor vehicle, which supplies electrical consumers of the vehicle with power. The on-board power system B has a DC voltage source 2, via which the on-board power system B is supplied with a DC voltage which has a first voltage level V1. The vehicle preferably has an on-board power system B which, at least during active operation of the vehicle, has the same rated voltage throughout the vehicle. This rated voltage is preferably 48V. In other words, no partial on-board power systems are provided which are operated at different voltage levels during active operation of the vehicle, for example a first partial on-board power system which is operated at a rated voltage of 12V and a second partial on-board power system which is operated at a rated voltage of 48V, as is the case for example in mild hybrid vehicles.

The on-board power system B comprises an electrical control unit 3 which is supplied with a DC voltage according to the first voltage level V1 at least during active operation of the vehicle. The electrical control unit 3 may be, in particular, a control device which provides vehicle functions even in the rest state or in the parked state of the vehicle. This is the case, for example, in control units for the parking brake or the vehicle locking system.

The on-board electrical system 1 also comprises a DC voltage source 2 which is designed to provide a DC voltage having a rated voltage according to the first voltage level V1. This rated voltage is preferably 48V.

The on-board electrical system 1 also comprises a voltage reduction unit 4. The voltage reduction unit 4 has a control input via which control information can be supplied to the voltage reduction unit 4. The voltage reduction unit 4 can be actuated via the control input in such a way that the on-board power system voltage is reduced at least in part of the on-board electrical system B. The electrical voltage which is made available to the electrical control unit 3 is therefore reduced, specifically to a second voltage level V2 which is lower than the first voltage level V1.

In the exemplary embodiment shown, the DC voltage source 2 is an on-board power system battery having a first battery pole P1 and a second battery pole P2. The rated voltage of the on-board power system battery between the first and second battery poles P1, P2 is preferably 48V.

The on-board power system battery preferably also has a center tap M. Within the context of an aspect of the present invention, “center tap” can mean a symmetrical or asymmetrical tap at the battery cells, i.e., the tap divides the battery into two regions with the same number of cells or into two regions with a different number of cells.

The center tap M can be, for example, an external pole or else can be provided in the interior of the on-board power system battery. If the center tap M is realized in the interior of the on-board power system battery, the voltage reduction unit 4 can likewise be provided in the interior of the on-board power system battery.

The second voltage level V2 is provided at the center tap M, i.e. the rated voltage of the on-board power system battery between the center tap M and the second battery pole P2 has the voltage V2. The second voltage level V2 can be in the range of 24 V to 40 V, in particular in the range from 24 V to 36 V, particularly preferably in the range from 24 V to 31 V, for example.

In the exemplary embodiment shown, the voltage reduction unit 4 has a switching unit 4.1. This switching unit 4.1 comprises a first input that is coupled to the first battery pole P1. In addition, the switching unit 4.1 comprises a second input, which is coupled to the center tap M. The switching unit 4.1 has switching means that can be used to switch over between the first and second inputs such that either the first or the second input of the switching unit 4.1 can be electrically coupled to the output of the switching unit 4.1.

By switching the switching unit 4.1 of the voltage reduction unit 4, it is therefore possible for the on-board electrical system B to be supplied with an on-board power system voltage at a first voltage level V1 in a first operating state of the vehicle and with a second voltage level V2 and thus with a reduced on-board power system voltage at least in one on-board power system sub-section.

The first operating state of the vehicle in this case is, in particular, a state in which the vehicle is activated and ready to drive, i.e., the vehicle is not in the parked state or the rest state. The second operating state is preferably a rest state or parked state in which the vehicle is deactivated and not ready to drive. In particular, the second operating state can also be characterized in that the vehicle is locked.

The voltage reduction unit 4 can reduce the on-board power system voltage immediately after the occurrence of the second operating state. Alternatively, it is possible to parameterize the reduction of the on-board power system voltage, i.e., to make it dependent on one or more conditions. A condition may for example be the expiry of a period of time. That is to say that the voltage reduction can be effected, in particular, when the vehicle is in the second operating state and, for example, a predefined time period has elapsed or the voltage of the DC voltage source 2 is below a predefined threshold.

It is to be understood that the reduction in the on-board power system voltage can take place in the entire on-board power system B of the vehicle or only in a sub-section of the on-board power system B.

The reduction in the on-board power system voltage has the advantage that the electrical losses which arise as a result of parasitic resistances or other leakage currents are reduced, since the leakage currents can be reduced with a low on-board power system voltage. Excessive discharging of the DC voltage source 2 can thus be prevented even during long standstill periods of the vehicle. The loads provided in the on-board power supply system, in particular the control units, are configured to provide their functionality even when the on-board power system voltage is reduced, in accordance with the international standard ISO 21780. It is thus possible to maintain the vehicle functions to be implemented in the second operating state of the vehicle despite the reduction in the on-board power system voltage.

FIG. 2 shows by way of example and schematically a further embodiment of an on-board electrical system 1. Below, only the differences with respect to the embodiment of FIG. 1 are described. Moreover, the above statements also apply to this embodiment.

The fundamental difference between the embodiment according to FIG. 2 and the embodiment according to FIG. 1 is that the DC voltage source 2 does not have a center tap. The DC voltage source 2 can therefore provide only an on-board power system voltage according to the first voltage level.

To reduce the on-board power system voltage, the on-board electrical system 1 has a voltage reduction unit 4, which is designed as a DC-DC converter 4.2. The DC-DC converter 4.2 has an input at which an on-board power system voltage with the first voltage level V1 is present. The DC-DC converter 4.2 is configured to reduce the on-board power system voltage from the first voltage level V1 to the second voltage level V2. Therefore, when the on-board power system voltage is actively reduced at the output of the DC-DC converter 4.2, an output voltage in accordance with the second voltage level V2 can be provided and the electrical control unit of the on-board power system B can be operated at the second voltage level V2.

FIG. 3 shows by way of example and schematically another further embodiment of an on-board electrical system 1. Below, only the differences with respect to the embodiments of FIG. 1 and FIG. 2 are described. Moreover, the above statements also apply to this embodiment.

By contrast to the previous embodiments, the voltage reduction unit 4 is not provided outside the DC voltage source 2, but instead is integrated in this DC voltage source 2. In this case, the voltage reduction unit 4 can be a switching unit 4.1 that switches between a positive pole and a center tap and thus provides an on-board power system voltage with a first voltage level V1 or with a second voltage level V2 at an external contact point of the DC voltage source 2, depending on the switching state.

Alternatively, the DC voltage source 2 can have an integrated DC-DC converter 4.2. The DC-DC converter 4.2 is configured to cause a conversion of the on-board power system voltage from the first voltage level V1 to the second voltage level V2. For example, the DC-DC converter 4.2 can convert a DC voltage having a rated voltage of 48V to a DC voltage having a rated voltage in the range from 24V to 40V, in particular in the range from 24V to 36V, particularly preferably in the range from 24V to 31V.

The DC voltage source 2 can be an on-board power system battery, which outputs a rated voltage of 48V as the first voltage level V1. Alternatively, the DC voltage source 2 can also be a drive battery of an electrically drivable vehicle (BEV: battery electric vehicle or PHEV: plug-in hybrid electric vehicle). A drive battery has for example a rated voltage in the range between 400V and 1000V. The drive battery can provide an on-board power system voltage for the vehicle by means of a voltage reduction unit 4 in the form of a DC/DC converter 4.2. The DC/DC converter can be configured to provide, in the first operating state of the vehicle, an on-board power system voltage in accordance with the first voltage level, for example 48V, and in the second operating state a reduced on-board power system voltage in accordance with the second voltage level, in the range from 24V to 40V, in particular in the range from 24V to 36V, particularly preferably in the range from 24V to 31V. It is thus possible for the drive battery to provide the on-board power system voltage, with the result that the vehicle does not need to have an on-board power system battery to provide the on-board power system voltage.

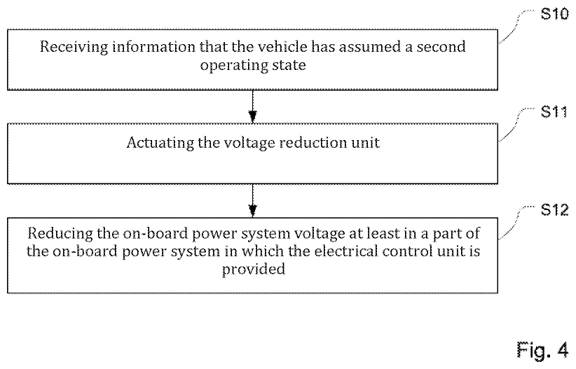

FIG. 4 shows a block diagram which illustrates the method steps of a method for providing an on-board power system voltage in an on-board electrical system 1 of a vehicle.

First, information is received indicating that the vehicle has assumed a second operating state, different from the first operating state (S10). By way of example, the vehicle may have been changed from a ready-to-drive state as the first state to a parking state or a rest state as the second operating state.

After the receiving of the information that the vehicle has assumed the second operating state, the voltage reduction unit is actuated (S11). This may take place immediately after assuming the second operating state or else may be subject to one or more conditions. A condition can be, for example, that the parking or rest state has been in place for a certain period of time.

Finally, the on-board power system voltage is reduced at least in a part of the on-board power system in which the electrical control unit is provided, such that an on-board power system voltage with the second voltage level which is lower than the first voltage level is applied to the electrical control unit (S12).

The invention has been described above based on exemplary embodiments. It is to be understood that numerous changes and modifications are possible without departing from the scope of protection defined by the claims.

List of reference numerals

| | |
|---|---|
| 1 | on-board electrical system |
| 2 | DC voltage source |
| 3 | electronic control unit |
| 4 | voltage reduction unit |
| 4.1 | switching unit |
| 4.2 | DC-DC converter |
| B | on-board power system |
| P₁ | first battery pole |
| P₂ | second battery pole |
| M | center tap |
| V₁ | first voltage level |
| V₂ | second voltage level |

1. An on-board electrical system for a motor vehicle, comprising a DC voltage source which provides a DC voltage having a first voltage level, wherein the on-board electrical system has at least one electrical control unit which is operated in a first operating state of the motor vehicle with an on-board power system voltage according to the first voltage level, wherein the on-board electrical system has a voltage reduction unit which can be actuated in a second operating state of the motor vehicle in such a way that the on-board power system voltage is reduced at least in a part of the on-board power system in which the electrical control unit is provided, such that an on-board power system voltage with a second voltage level which is lower than the first voltage level is applied to the electrical control unit.

2. The on-board electrical system as claimed in claim 1, wherein the rated voltage of the first voltage level is 48V or substantially 48V.

3. The on-board electrical system as claimed in claim 1, wherein the rated voltage of the second voltage level is in the range between 24V and 40V.

4. The on-board electrical system as claimed in claim 1, wherein the voltage reduction unit comprises a switching unit (4.1) which is coupled to or integrated in a DC voltage source in the form of an on-board power system battery which has a rated voltage of 48V, wherein the on-board power system battery has a first battery pole as a positive pole, a second battery pole as a ground pole, and a center tap, wherein the second voltage level can be provided via the center tap.

5. The on-board electrical system as claimed in claim 4, wherein the switching unit causes switching between an electrical connection to the first battery pole and an electrical connection to the center tap.

6. The on-board electrical system as claimed in claim 1, wherein the voltage reduction unit has a DC-DC converter.

7. The on-board electrical system as claimed in claim 6, wherein the voltage reduction unit is integrated in a drive battery of the motor vehicle and the on-board power system voltage with the first and second voltage levels is supplied by this drive battery.

8. The on-board electrical system as claimed in claim 7, wherein no on-board power system battery is provided as a separate battery in addition to the drive battery.

9. The on-board electrical system as claimed in claim 6, wherein the DC-DC converter is coupled to an on-board power system battery of the motor vehicle which has a rated voltage of 48V or substantially 48V, and in that the DC-DC converter is designed to reduce the on-board power system voltage from the first voltage level to the second voltage level.

10. The on-board electrical system as claimed in claim 1, wherein the second operating state of the motor vehicle is a rest state and/or a parked state.

11. The on-board electrical system as claimed in claim 10, wherein the reduction to the second voltage level can be parameterized, specifically in such a way that the on-board power system voltage is reduced to the second voltage level if, in addition to assuming the parked state and/or the rest state of the motor vehicle, at least one further condition is satisfied.

12. The on-board electrical system as claimed in claim 1, wherein the on-board power system of the motor vehicle has a plurality of on-board power system sections and the reduction of the on-board power system voltage to the second voltage level takes place only in some of the on-board power system sections.

13. A motor vehicle comprising an on-board electrical system as claimed claim 1.

14. A method for providing an on-board power system voltage in an on-board power system of a motor vehicle, wherein the on-board electrical system has a DC voltage source by which a DC voltage having a first voltage level is provided, wherein the on-board electrical system has at least one electrical control unit which is operated in a first operating state of the motor vehicle with an on-board power system voltage according to the first voltage level, wherein the on-board electrical system has a voltage reduction unit, wherein the method comprises:
receiving information indicating that the motor vehicle has assumed a second operating state which is different from the first operating state;
actuating the voltage reduction unit;
reducing the on-board power system voltage at least in a part of the on-board power system in which the electrical control unit is provided, such that an on-board power system voltage with a second voltage level which is lower than the first voltage level is applied to the electrical control unit.

15. The on-board electrical system as claimed in claim 2, wherein the rated voltage of the second voltage level is in the range between 24V and 40 V
